(19) United States
(12) Patent Application Publication
(10) Pub. No.: US 2020/0172789 A1
(43) Pub. Date: Jun. 4, 2020

(54) COMPOSITION AND METHOD FOR A SELF-SUSPENDING LOST CIRCULATION MATERIAL FLUID SYSTEM

(71) Applicant: ProAction Fluids LLC, Shreveport, LA (US)

(72) Inventors: Nathan R. Hutchings, Shreveport, LA (US); John Paxton Monsour, Shreveport, LA (US); Stewart Simpson, Jefferson, TX (US)

(21) Appl. No.: 16/204,062

(22) Filed: Nov. 29, 2018

(51) Int. Cl. C09K 8/508; C09K 8/514; C09K 8/516

(52) U.S. Cl. CPC C09K 8/5086; C09K 8/5083; C09K 8/516; C09K 8/514

(57) ABSTRACT

A well fluid composition includes powdered polylactic acid having a selected melting temperature below a lowest expected temperature of a subsurface formation into which the composition is to be introduced. The composition includes powdered polymer suspension aide and/or viscosifier in an amount which when hydrated enables suspension of the powdered polylactic acid in liquid for at least 2 hours and up to 24 hours. The powdered polylactic acid and the powdered polymer solids suspension aide and/or viscosifier are mixed with a liquid capable of hydrating the powdered polymer solids suspension aide and/or viscosifier.

### CROSS REFERENCE TO RELATED APPLICATIONS

Not Applicable.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of subsurface wellbore construction and remediation fluids. More particularly, the disclosure relates to compositions for wellbore fluids that can be used in wells hydraulically connected to subsurface formations having fluid pressure lower than the pressure necessary to support a liquid column to surface within the well.

During subsurface wellbore construction, treatment and remediation, for example, in post-fracture treatment well completion, many hydrocarbon productive geological strata (subsurface formations) lack sufficient in-situ reservoir pressure to support (hydrostatic pressure of) a column of liquid in the wellbore. In such formations, liquid in the well cannot be effectively circulated, that is, returned to surface by pumping liquid into the wellbore using known well treatment liquids such as slickwater and/or gel sweeps. In such low bottom-hole pressure (“LBHP”) wellbore operations, the inability to circulate liquid, either in the wellbore itself or the annular space between the wellbore and a conduit (casing or tubing) during certain procedures may present operational challenges, one of which is the inability to effectively use a liquid system to clean debris (e.g., sand and plug parts) out of the well. Additionally, movement out of the well of wellbore fluid and fluid additives into formations in hydraulic communication with the wellbore may be undesirable due to the potentially negative impact on fracture treatment in such formations, e.g., the proppant pack and/or the formation itself. LBHP methods known in the art make use of gas injection, e.g., nitrified and/or gas-energized liquid systems to lower the liquid density, and correspondingly the hydrostatic pressure exerted by the liquid sufficiently to enable circulation. LBHP methods known in the art also use fluid containing suspended solids (lost circulation material—“LCM”), such as rock salt or calcium carbonate powder to create an impermeable barrier on such formations as wellbore fluid enters, thereby substantially stopping further wellbore fluid entry. Both types of such methods may be expensive and present further operational challenges. A need exists for a convenient, lower cost and less-damaging alternative to LBHP systems and methods known in the art that can enable the well fluid circulation.

### SUMMARY

A well fluid composition according to one aspect of the disclosure includes powdered polylactic acid having a selected melting temperature below a lowest expected temperature of a subsurface formation into which the composition is to be introduced. The composition includes powdered polymer suspension aide and/or viscosifier in an amount which when hydrated enables suspension of the powdered polylactic acid in liquid for at least two hours. The powdered polylactic acid and the powdered polymer solids suspension aide and/or viscosifier are mixed with a liquid capable of hydrating the powdered polymer.

In some embodiments, the liquid comprises a water based liquid.

In some embodiments, the liquid comprises at least one of fresh water and brine.

In some embodiments, a concentration of the powdered polylactic acid comprises 50 to 70 percent by weight and a concentration of the powdered polymer solids suspension aide and/or viscosifier comprises 30 to 50 percent by weight.

In some embodiments, the powdered polymer solids suspension aide and/or viscosifier comprises at most 10 percent by weight of powdered anionic polyacrylamide and at least 90 percent by weight powdered AMPS-polyacrylate copolymer.

In some embodiments, 35 to 100 pounds of mixed powdered polymer solids suspension aide and/or viscosifier and powdered polylactic acid is mixed with 10 barrels of liquid.

In some embodiments, mixed powdered polymer and powdered polylactic acid comprises 0.1 to 3% by total weight of the liquid and the mixed powdered polymer solids suspension aide and/or viscosifier and powdered polylactic acid.

In some embodiments, the solids suspension aide and/or viscosifier comprises at least one of AMPS (2-Acrylamido-2-methylpropane sulfonic acid) polyacrylate co-polymer, polyacrylamide, guar, xanthan, and derivatized cellulose polymer.

In some embodiments, the selected melting temperature is at most 90 degrees Fahrenheit.

In some embodiments, the selected melting temperature is at most 150 degrees Fahrenheit.

A method according to another aspect of the disclosure relates to placing a liquid column in a wellbore exposed to a subsurface formation having a fluid pressure lower than a hydrostatic pressure of the liquid column. A method according to this aspect includes pumping a composition into the wellbore, wherein the composition comprises powdered polylactic acid having a selected melting temperature. The selected melting temperature is below a lowest expected temperature of a subsurface formation into which the composition is to be introduced. The composition further comprises powdered polymer solids suspension aide and/or viscosifier in an amount which when hydrated enables suspension of the powdered polylactic acid in liquid for at least at least 2 hours. The powdered polylactic acid and the powdered polymer solids suspension aide and/or viscosifier are mixed with a liquid capable of hydrating the powdered polymer solids suspension aide and/or viscosifier. The method further includes waiting until a filter cake forms on the subsurface formation so as to substantially stop liquid infiltration into the subsurface formation from the wellbore.

Some embodiments further comprising pumping fluid into the wellbore after pumping the composition so as to circulate solids out of the wellbore.

In some embodiments, the solids comprise at least one of fracture proppant and well equipment debris.

Other aspects and advantages will be apparent from the description and claims that follow.

### DETAILED DESCRIPTION

A fluid composition according to the present disclosure may provide a water base fluid containing a self-suspending, self-degrading lost circulation material (“LCM”) to temporarily seal off permeable formations during e.g., well completion procedures.

A composition according to the present disclosure may comprise one or a blend of a powdered or granular viscosity-building solids suspension aides (“viscosifiers”) such as AMPS (2-Acrylamido-2-methylpropane sulfonic acid) polyacrylate co-polymer and/or polyacrylamide, guar, xanthan, or derivatized cellulose polymer premixed with low melting point (temperature) finely ground polylactic acid (PLA) granules. The PLA granules act as LCM. The combined viscosifier-PLA mixture may be added to a base fluid (liquid or liquid mixture), generally fresh water or a weakly concentrated brine, and the polymers are then allowed to hydrate. Once the polymer(s) hydrate, the polymer(s) and PLA (LCM) form a stable suspension that can be stored for extended time (e.g., 2 to 24 hours) without the PLA settling out of suspension. Such suspension may be readily pumped into a wellbore to form a permeability barrier against permeable formations having reservoir pressure lower than hydrostatic pressure of a column of water (or the suspension described herein), where such formations are in hydraulic communication with the wellbore. Such formations may comprise proppant after hydraulic fracture treatment. As the viscosifier-PLA suspension encounters such formations, the pressure of the hydrostatic column of the suspension causes some fluid to be hydraulically forced (squeezed) into the formations; but as this happens, the PLA starts to form a substantially impermeable filter cake on the formation pores, restricting further fluid flow. Eventually a sufficiently impermeable filter cake is formed so as to prevent further entry of the suspension, and therefore enabling the well to retain and circulate the remaining fluid in the wellbore back to surface. “Low melting point” as used in the present context means a temperature below the lowest expected temperature of any permeable formations to which the PLA may be introduced by hydrostatic pressure during well operations.

The use of AMPS copolymer and/or polyacrylamide as the principal suspension aide not only provides unique rheological suspension properties but also serves to reduce fluid-on-pipe friction, and therefore allows higher fluid circulation rate as compared to non-friction reduced fluids. The polymer-PLA suspension can be run continuously or as high concentration “pills” as needed. The dosage of the polymer-PLA mixture into the base fluid can be varied to identify the optimum, e.g., minimum dosage required to provide a sufficient seal against any permeable, low pressure formation.

Compositions according to the present disclosure are also compatible with many other well completion fluid additives such as conventional polyacrylamide-based friction reducers, biocides, corrosion inhibitors, gel breaking agents, surfactants, lubricants, and the like. Due to the low-melting temperature of the PLA, there is no need to introduce acids or other chemicals into the wellbore to remove the LCM after any particular procedure is completed. The PLA may be expected to melt in a time interval of hours to days, depending on the specific formation temperature(s). Melted PLA may be subsequently removed with the fracture treatment fluids when the well is “flowed back” prior to reservoir fluid production. The combination of a self-suspending material in the form of a stable, easy to pump suspension that also reduces the pumping pressure requirements (by reason of friction reduction) to obtain optimum circulation rates is believed to be a unique combination.

In one embodiment, 30 to 40% by weight powdered AMPS-polyacrylate copolymer may be combined with 0-10% by weight of powdered anionic polyacrylamide and 50 to 70% low melting point (e.g. below about 150° F.) 20/40 mesh PLA. The foregoing mixture may be combined in a trammel, paddle mixer, auger, or mortar-mixer-style mixing apparatus until a substantially homogeneous powdered solid mixture is formed. Optionally, up to 5% by weight low VOC/high flash point oil may be added to prevent clumping and facilitate dispersion when introduced into the base fluid (or fluid system). In one embodiment, 29% AMPS-polyacrylate copolymer is combined with 10% anionic polyacrylamide, 58% low melting point (90° F.) PLA, and 3% soybean oil. Optionally, a few ounces of marker dye powder may be added to the mixture to enable the fluid to be traced when circulated through the well bore. In this embodiment, a 1% (by wt.) hydrated suspension in fresh water is stable for over 24 hours at ambient temperature (i.e., 72° F.) and the PLA melts in 12 to 24 hours at 165° F.

A method according to the present disclosure to treat a LBHP formation, e.g., during well completion procedures may comprise combining the above described homogenous polymer-PLA mixture with the base fluid (e.g., water or brine), for example, at a well site. The combination may be, for example, at concentrations of 0.1 to 3% by weight of the powdered mixture in the base fluid. The combined mixture and base fluid may be pumped, e.g., using a coiled-tubing unit or workover rig, into a well and circulated back to surface. In one example embodiment, 70 lbs. of the powdered mixture described above can be mixed with 10 barrels (each barrel being American Petroleum Institute standard, 42 U.S. gallons) of base fluid to form an effective “pill” (˜1% by polymer weight) which may be pumped into the wellbore as a “pill” (a separate slug) along with other well construction, remediation and/or completion fluid. One or more such pills may be pumped into the well to stop fluid loss into a permeable formation. In another example embodiment, the powdered mixture may be combined with base fluid at a rate of 7 lbs per 10 barrels of base fluid, wherein such fluid is introduced into the wellbore for an effective constant “dose” of 0.1% by polymer weight. The foregoing application methods (pills or continuous dose) can be introduced into a well simultaneously or independently as needed to maintain an effective (substantially impermeable) filter cake on permeable formations. The frequency of introducing pills and/or constant dose fluid may be determined by monitoring fluid pressure and fluid return flow rate from the well such that flow balance (rate of flow into the well substantially matching fluid flow rate out of the well) is maintained throughout the particular wellbore procedure.

Although only a few examples have been described in detail above, those skilled in the art will readily appreciate that many modifications are possible in the examples. Accordingly, all such modifications are intended to be included within the scope of this disclosure as defined in the following claims.

What is claimed is:

1. A well fluid composition, comprising:
powdered polylactic acid having a selected melting temperature, the selected melting temperature below a lowest expected temperature of a subsurface formation into which the composition is to be introduced;
powdered polymer solids suspension aide and/or viscosifier in an amount which when hydrated enables suspension of the powdered polylactic acid in liquid for at least at least 2 hours ; and
wherein the powdered polylactic acid and the powdered polymer solids suspension aide and/or viscosifier are mixed with a liquid capable of hydrating the powdered polymer solids suspension aide and/or viscosifier.

2. The composition of claim 1 wherein the liquid comprises a water based liquid.

3. The composition of claim 2 wherein the liquid comprises at least one of fresh water and brine.

4. The composition of claim 1 wherein a concentration of the powdered polylactic acid comprises 50 to 70 percent by weight and a concentration of the powdered polymer solids suspension aide and/or viscosifier comprises 30 to 50 percent by weight.

5. The composition of claim 4 wherein the powdered polymer comprises at most 10 percent by weight of powdered anionic polyacrylamide and at least 90 percent by weight powdered AMPS-polyacrylate copolymer.

6. The composition of claim 5 wherein 35 to 70 pounds of mixed powdered polymer solids suspension aide and/or viscosifier and powdered polylactic acid is mixed with 10 barrels of liquid.

7. The composition of claim 5 wherein mixed powdered polymer solids suspension aide and/or viscosifier and powdered polylactic acid comprises 0.1 to 3% by total weight of the liquid and the mixed powdered polymer and powdered polylactic acid.

8. The composition of claim 1 wherein the powdered suspension aide and/or viscosifier comprises at least one of AMPS (2-Acrylamido-2-methylpropane sulfonic acid) polyacrylate co-polymer, polyacrylamide, guar, xanthan, and derivatized cellulose polymer.

9. The composition of claim 1 wherein the selected melting temperature is at most 90 degrees Fahrenheit.

10. The composition of claim 1 wherein the selected melting temperature is at most 150 degrees Fahrenheit.

11. A method for placing a liquid column in a wellbore exposed to a subsurface formation having a fluid pressure lower than a hydrostatic pressure of the liquid column, comprising:
pumping a composition into the wellbore, the composition comprising powdered polylactic acid having a selected melting temperature, the selected melting temperature below a lowest expected temperature of a subsurface formation into which the composition is to be introduced, the composition comprising powdered polymer solids suspension aide and/or viscosifier in an amount which when hydrated enables suspension of the powdered polylactic acid in liquid for at least at least 2 hours, wherein the powdered polylactic acid and the powdered polymer solids suspension aide and/or viscosifier are mixed with a liquid capable of hydrating the powdered polymer solids suspension aide and/or viscosifier; and
waiting until a filter cake forms on the subsurface formation so as to substantially stop liquid infiltration into the subsurface formation from the wellbore.

12. The method of claim 11 further comprising pumping fluid into the wellbore after pumping the composition so as to circulate solids out of the wellbore.

13. The method of claim 12 wherein the solids comprise at least one of fracture proppant and well equipment debris.

14. The method of claim 11 wherein the liquid comprises at least one of fresh water and brine.

15. The method of claim 11 wherein a concentration of the powdered polylactic acid comprises 50 to 70 percent by weight and a concentration of the powdered polymer solids suspension aide and/or viscosifier comprises 30 to 50 percent by weight.

16. The method of claim 15 wherein the powdered polymer comprises at most 10 percent by weight of powdered anionic polyacrylamide and at least 90 percent by weight powdered AMPS-polyacrylate copolymer.

17. The method of claim 16 wherein 35 to 70 pounds of mixed powdered polymer solids suspension aide and/or viscosifier and powdered polylactic acid is mixed with 10 barrels of liquid.

18. The method of claim 16 wherein mixed powdered polymer solids suspension aide and/or viscosifier and powdered polylactic acid comprises 0.1 to 3% by total weight of the liquid and the mixed powdered polymer and powdered polylactic acid.

19. The method of claim 11 wherein the powdered suspension aide and/or viscosifier comprises at least one of AMPS (2-Acrylamido-2-methylpropane sulfonic acid) polyacrylate co-polymer, polyacrylamide, guar, xanthan, and derivatized cellulose polymer.

20. The method of claim 11 wherein the selected melting temperature is at most 90 degrees Fahrenheit.
